(19) United States
(12) Patent Application Publication
(10) Pub. No.: US 2024/0304906 A1
(43) Pub. Date: Sep. 12, 2024

(54) ELECTROCHEMICAL APPARATUS AND ELECTRIC DEVICE

(71) Applicant: Xiamen Ampack Technology Limited, Xiamen (CN)

(72) Inventor: Xia YANG

(73) Assignee: Xiamen Ampack Technology Limited, Xiamen (CN)

(21) Appl. No.: 18/598,376

(22) Filed: Mar. 7, 2024

(30) Foreign Application Priority Data
Mar. 8, 2023 (CN) 202310218688.X

(51) Int. Cl. H01M 50/143; H01M 50/247; H01M 50/253; H01M 50/298

(52) U.S. Cl. CPC H01M 50/143; H01M 50/247; H01M 50/253; H01M 50/298

(57) ABSTRACT

An electric device includes a first housing, a second housing, a cell assembly, a fire extinguisher, and a first wire. The second housing includes a first surface, the fire extinguisher is disposed on the first surface, and the fire extinguisher includes a first side, a second side, a third side, and a fourth side. The first wire is disposed on the first surface, and the first wire includes a first part, a second part, and a third part, where the first part, the second part, and the third part are connected in sequence. A portion of the first part is opposite to the first side, a portion of the second part is opposite to the second side, a portion of the third part is opposite to the third side, and the first part is connected to the first side.

### CROSS-REFERENCE TO RELATED APPLICATION

This application claims priority from Chinese Patent Application No. 202310218688.X, filed on Mar. 8, 2023, the content of which is incorporated herein by reference in its entirety.

### TECHNICAL FIELD

This application relates to the field of battery technologies, and in particular, to an electrochemical apparatus and an electric device.

### BACKGROUND

In an electrochemical apparatus including a battery module, to address the possible issues such as abnormal high temperature or abnormal fire in a battery, a fire-fighting structure is generally provided. The fire-fighting structure includes a fire extinguisher, a temperature-sensing control module, and the like. When sensing an abnormal temperature or flame in the electrochemical apparatus, the temperature-sensing control module can trigger the fire extinguisher to cool or extinguish fire. However, a probe of the temperature-sensing control module has a limited sensing range and thus cannot rapidly respond to abnormal high temperatures or flames in different regions of the electrochemical apparatus, which may affect the cooling or fire extinguishing effect.

### SUMMARY

In view of the foregoing situation, it is necessary to provide an electrochemical apparatus, so as to increase a response speed of a fire extinguisher to abnormal high temperatures or fires in different regions of the electrochemical apparatus.

An embodiment of this application provides an electrochemical apparatus including a first housing, a second housing, a cell assembly, a fire extinguisher, and a first wire. The second housing and the first housing are arranged in a first direction, the second housing and the first housing are connected to each other to form an accommodating space, and the cell assembly, the fire extinguisher, and the first wire are disposed in the accommodating space. The second housing includes a first surface, where the first surface faces the first housing in the first direction. The fire extinguisher is connected to the first surface, and the fire extinguisher includes a first side, a second side, a third side, and a fourth side, where the first side and the third side are arranged in a second direction perpendicular to the first direction, the second side and the fourth side are arranged in a third direction perpendicular to the first direction and the second direction, the first side is connected to the second side and the fourth side, and the third side is connected to the second side and the fourth side. The first wire is connected to the first surface, the first wire and the cell assembly are arranged along the first direction, and the first wire includes a first part, a second part, and a third part, where the first part, the second part, and the third part are connected in sequence, a portion of the first part is opposite to the first side in the second direction, a portion of the second part is opposite to the second side in the third direction, a portion of the third part is opposite to the third side in the second direction, and the first part is connected to the first side.

In the electrochemical apparatus of this application, the fire extinguisher and the first wire are disposed on the first surface of the second housing, the portion of the first part is opposite to the first side of the fire extinguisher in the second direction, the portion of the second part is opposite to the second side in the third direction, and the portion of the third part is opposite to the third side in the second direction. This is conducive to enlarging a sensing range of the first wire without increasing the length of the first wire, so as to increase the response speed of the fire extinguisher to abnormal high temperatures or flames, thereby improving the safety performance of the electrochemical apparatus.

In some embodiments of this application, the first wire further includes a fourth part, where the fourth part is connected to the third part, and a portion of the fourth part is opposite to the fourth side in the third direction. The provision of the fourth part is conducive to enlarging the sensing range of the first wire, so as to increase the response speed of the fire extinguisher to abnormal high temperatures or flames, thereby improving the safety performance of the electrochemical apparatus.

In some embodiments of this application, when viewed in the first direction, the second part is apart from the second side, the third part is apart from the third side, and the fourth part is apart from the fourth side, so that the first wire surrounds the fire extinguisher. This is conducive to enlarging the sensing range of the first wire, so as to increase the response speed of the fire extinguisher to abnormal high temperatures or flames, thereby improving the safety performance of the electrochemical apparatus.

In some embodiments of this application, the electrochemical apparatus further includes a second wire, where the second wire is disposed on the first surface, the second wire and the cell assembly are arranged along the first direction, and the second wire includes a fifth part, a sixth part, and a seventh part, where the fifth part, the sixth part, and the seventh part are connected in sequence, a portion of the fifth part is opposite to the third side in the second direction, a portion of the sixth part is opposite to the second side in the third direction, a portion of the seventh part is opposite to the first side in the second direction, and the fifth part is connected to the third side. The second wire is provided and the second wire cooperates with the first wire to sense different regions of the electrochemical apparatus, which is conducive to increasing the response speed of the fire extinguisher to abnormal high temperatures or flames, thereby improving the safety performance of the electrochemical apparatus.

In some embodiments of this application, the second wire further includes an eighth part, where the eighth part is connected to the seventh part, and a portion of the eighth part is opposite to the fourth side in the third direction. The provision of the eighth part is conducive to enlarging a sensing range of the second wire, so as to increase the response speed of the fire extinguisher to abnormal high temperatures or flames, thereby improving the safety performance of the electrochemical apparatus.

In some embodiments of this application, when viewed in the first direction, the sixth part is apart from the second side, the seventh part is apart from the first side, and the eighth part is apart from the fourth side, so that the second wire surrounds the fire extinguisher. This is conducive to enlarging the sensing range of the second wire, so as to increase the response speed of the fire extinguisher to abnormal high temperatures or flames, thereby improving the safety performance of the electrochemical apparatus.

In some embodiments of this application, when viewed in the first direction, the second part and the fifth part intersect to form a first intersection point. This is conducive to reducing sensing blind regions of the first wire and the second wire and enlarging the sensing ranges of the first wire and the second wire, so as to increase the response speed of the fire extinguisher to abnormal high temperatures or flames, thereby improving the safety performance of the electrochemical apparatus.

In some embodiments of this application, when viewed in the second direction, the first intersection point is apart from the third side; and when viewed in the third direction, the first intersection point is apart from the second side. The adjustment of a position of the first intersection point is conducive to reducing the sensing blind regions of the first wire and the second wire and enlarging the sensing ranges of the first wire and the second wire, so as to increase the response speed of the fire extinguisher to abnormal high temperatures or flames, thereby improving the safety performance of the electrochemical apparatus.

In some embodiments of this application, when viewed in the first direction, the first surface includes a first region, where the first region is enclosed by the first wire, the second wire, the first side, the second side, and the third side, and the first region is apart from the fourth side.

In some embodiments of this application, the first wire further includes a first bent part, where the first part and the second part are connected through the first bent part.

In some embodiments of this application, when viewed in the second direction, the first bent part is apart from the fire extinguisher; and when viewed in the third direction, the first bent part is apart from the fire extinguisher.

In some embodiments of this application, the second wire further includes a second bent part, where the fifth part and the sixth part are connected through the second bent part.

In some embodiments of this application, when viewed in the second direction, the second bent part is apart from the fire extinguisher; and when viewed in the third direction, the second bent part is apart from the fire extinguisher.

In some embodiments of this application, when viewed in the first direction, the fourth part and the eighth part intersect, and an intersection region of the fourth part and the eighth part and the fourth side are arranged along the third direction.

In some embodiments of this application, when viewed in the first direction, the first surface includes a second region, where the second region is enclosed by the first wire, the second wire, the third side, the fourth side, and the first side, and the second region is apart from the second side.

In some embodiments of this application, a length of the fourth side in the second direction is greater than a length of the third side in the third direction. In the third direction, a minimum distance between the fourth part and the fourth side is a first distance, and in the second direction, a minimum distance between the third part and the third side is a second distance, where the first distance is less than the second distance.

In some embodiments of this application, the fourth part and the eighth part intersect to form a second intersection point, where the second intersection point is opposite to the fourth side in the third direction. This is conducive to spreading of flames on the first wire and the second wire to the fire extinguisher in the shortest path when either of the first wire or the second wire is ignited by flame, so as to increase the response speed of the fire extinguisher to abnormal high temperatures or flames, thereby improving the safety performance of the electrochemical apparatus.

In some embodiments of this application, the fourth part includes a first end portion and a second end portion, where the first end portion is connected to the third part, and in the second direction, the first end portion is closer to the third part than the second end portion, and the second intersection point is located between the first end portion and the second end portion. This is conducive to enlarging the sensing range of the first wire, so as to increase the response speed of the fire extinguisher to abnormal high temperatures or flames, thereby improving the safety performance of the electrochemical apparatus.

In some embodiments of this application, the eighth part includes a third end portion and a fourth end portion, where the third end portion is connected to the seventh part, and in the second direction, the third end portion is closer to the seventh part than the fourth end portion, and the second intersection point is located between the third end portion and the fourth end portion. This is conducive to enlarging the sensing range of the second wire, so as to increase the response speed of the fire extinguisher to abnormal high temperatures or flames, thereby improving the safety performance of the electrochemical apparatus.

In some embodiments of this application, when viewed in the third direction, an end portion of the fourth part far away from the third part exceeds the second intersection point, and an end portion of the eighth part far away from the seventh part exceeds the second intersection point. This is conducive to enlarging the sensing ranges of the first wire and the second wire, so as to increase the response speed of the fire extinguisher to abnormal high temperatures or flames, thereby improving the safety performance of the electrochemical apparatus.

In some embodiments of this application, the first surface has a fifth side and a sixth side connected to each other, where the fifth side extends along the second direction, a portion of the fifth side is opposite to the fourth side in the third direction, the sixth side extends along the third direction, and a portion of the sixth side is opposite to the third side in the second direction. In the third direction, a minimum distance between the fourth part and the fifth side is a third distance, and in the second direction, a minimum distance between the third part and the sixth side is a fourth distance, where the third distance is greater than the fourth distance.

In some embodiments of this application, the first distance is less than the third distance, which is conducive to reducing the length of the first wire and reducing costs while ensuring that the first wire senses abnormal high temperatures or fires.

In some embodiments of this application, in the first direction, a projection of the first wire overlaps a projection of the cell assembly.

In some embodiments of this application, in the first direction, a projection of the second wire overlaps the projection of the cell assembly.

In some embodiments of this application, the electrochemical apparatus further includes a third wire, where the third wire is disposed on the first surface, the third wire and the cell assembly are arranged along the first direction, and the third wire includes a first section, a second section, and a third section, where the first section, the second section, and the third section are connected in sequence, a portion of the first section is opposite to the first side in the second direction, a portion of the second section is opposite to the fourth side in the third direction, a portion of the third section is opposite to the third side in the second direction, and the first section is connected to the first side.

In some embodiments of this application, when viewed in the first direction, the first part and the first section intersect.

In some embodiments of this application, when viewed in the first direction, the third part and the third section intersect.

In some embodiments of this application, when viewed in the first direction, the first part is apart from the first section.

In some embodiments of this application, when viewed in the first direction, the third part is apart from the third section.

An embodiment of this application further provides an electric device including the electrochemical apparatus according to any one of the foregoing embodiments.

In the electrochemical apparatus of the electric device in this application, the fire extinguisher and the first wire are disposed on the first surface of the second housing, the portion of the first part is opposite to the first side of the fire extinguisher in the second direction, the portion of the second part is opposite to the second side in the third direction, and the portion of the third part is opposite to the third side in the second direction. This is conducive to enlarging the sensing range of the first wire without increasing the length of the first wire, so as to increase the response speed of the fire extinguisher to abnormal high temperatures or flames, thereby improving the safety performance of the electrochemical apparatus and improving the safety performance of the electric device.

### BRIEF DESCRIPTION OF DRAWINGS

FIG. 1 is a schematic structural diagram of an electrochemical apparatus according to an embodiment of this application.

FIG. 2 is an exploded view of an electrochemical apparatus according to an embodiment of this application.

FIG. 3 is a view of a partial structure of an electrochemical apparatus according to an embodiment of this application in a first direction.

FIG. 4 is a schematic structural diagram showing that a fire extinguisher and a first wire are disposed on a first surface according to an embodiment of this application.

FIG. 5 is a view of a partial structure of an electrochemical apparatus according to an embodiment of this application in a first direction.

FIG. 6 is a schematic structural diagram showing that a fire extinguisher and a first wire are disposed on a first surface according to an embodiment of this application.

FIG. 7 is a view of a partial structure of an electrochemical apparatus according to an embodiment of this application in a first direction.

FIG. 8 is a schematic structural diagram showing that a fire extinguisher, a first wire, and a second wire are disposed on a first surface according to an embodiment of this application.

FIG. 9 is a view of a partial structure of an electrochemical apparatus according to an embodiment of this application in a first direction.

FIG. 10 is a schematic structural diagram showing that a fire extinguisher, a first wire, and a second wire are disposed on a first surface according to an embodiment of this application.

FIG. 11 is a view of a partial structure of an electrochemical apparatus according to an embodiment of this application in a first direction.

FIG. 12 is a schematic structural diagram showing that a fire extinguisher, a first wire, and a third wire are disposed on a first surface according to an embodiment of this application.

FIG. 13 is a schematic structural diagram showing that a fire extinguisher, a first wire, and a third wire are disposed on a first surface according to an embodiment of this application.

FIG. 14 is a schematic structural diagram showing that a fire extinguisher, a first wire, and a third wire are disposed on a first surface according to an embodiment of this application.

FIG. 15 is a schematic structural diagram showing that a fire extinguisher, a first wire, and a third wire are disposed on a first surface according to an embodiment of this application.

FIG. 16 is a schematic structural diagram showing that a fire extinguisher, a first wire, and a third wire are disposed on a first surface according to an embodiment of this application.

FIG. 17 is a schematic structural diagram showing that a fire extinguisher, a first wire, and a third wire are disposed on a first surface according to an embodiment of this application.

FIG. 18 is a schematic structural diagram showing that a fire extinguisher, a first wire, and a third wire are disposed on a first surface according to an embodiment of this application.

FIG. 19 is a schematic structural diagram showing that a fire extinguisher, a first wire, and a third wire are disposed on a first surface according to an embodiment of this application.

FIG. 20 is a schematic structural diagram of an electric device according to an embodiment of this application.

### REFERENCE SIGNS OF MAIN COMPONENTS

Electrochemical apparatus 100

First housing 11

First wall 111

Second wall 112

Third wall 113

Fourth wall 114

Fifth wall 115

Recess 116

Second housing 12

First surface 121

First region 1211

Second region 1212

Fifth side 1213

Sixth side 1214

Seventh side 1215

Eighth side 1216

Accommodating space 13

Cell assembly 20

Cell unit 21

Cell body 211

Electrode terminal 212

Fire extinguisher 30

First side 31

Second side 32

Third side 33

Fourth side 34

First wire 41

First part 411

Second part 412

Third part 413

Fourth part 414

First end portion 4141

Second end portion 4142

First bent part 415

Third bent part 416

Fourth bent part 417

Second wire 42

Fifth part 421

Sixth part 422

Seventh part 423

Eighth part 424

Third end portion 4241

Fourth end portion 4242

Second bent part 425

Fifth bent part 426

Sixth bent part 427

Third wire 43

First section 431

Second section 432

Third section 433

First structural member 51

Circuit board 52

First intersection point 61

Second intersection point 62

Third intersection point 63

Fourth intersection point 64

Fifth intersection point 65

Sixth intersection point 66

Seventh intersection point 67

Eighth intersection point 68

Electric device 200

First direction Z

Second direction X

Third direction Y

This application will be further described with reference to the accompanying drawings in the following specific embodiments.

### DETAILED DESCRIPTION

The following describes the technical solutions in some embodiments of this application with reference to the accompanying drawings in these embodiments of this application. Apparently, the described embodiments are some but not all embodiments of this application.

It should be noted that when one component is assumed as being “connected to” another component, it may be connected to the another component directly or with a component possibly present therebetween. When one component is assumed as being “disposed on/in” another component, the component may be provided directly on/in the another component or with a component possibly present therebetween. In this application, unless otherwise specified and defined explicitly, the terms “mounting”, “connection”, “join”, “fastening”, and the like should be understood in their general senses. For example, they may refer to a fixed connection, a detachable connection, or an integral connection, may refer to a mechanical connection or an electrical connection, and may refer to a direct connection, an indirect connection via an intermediate medium, or an internal communication between two elements. Persons of ordinary skills in the art can understand specific meanings of these terms in this application as appropriate to specific situations. The term “and/or” used herein includes any and all combinations of one or more associated items listed.

Unless otherwise defined, all technical and scientific terms used herein shall have the same meanings as commonly understood by those skilled in the art to which this application pertains. The terms used herein in the specification of this application are for description of specific embodiments only without any intention to limit this application. The terms “comprise”, “include”, and any variants thereof in the descriptions of the specification, claims, and accompanying drawings of this application are intended to cover a non-exclusive inclusion.

In the description of some embodiments of this application, the terms “first”, “second”, and the like are merely intended to distinguish between different objects, and shall not be understood as any indication or implication of relative importance or any implicit indication of the number, sequence or primary-secondary relationship of the technical features indicated. In the description of some embodiments of this application, “a plurality of” means at least two unless otherwise specifically stated.

Reference to “embodiment” in this application means that specific features, structures, or characteristics described with reference to some embodiments may be included in at least one embodiment of this application. The word “embodiment” appearing in various places in the specification does not necessarily refer to the same embodiment or an independent or alternative embodiment that is exclusive of other embodiments. In absence of conflicts, various embodiments in this application may be combined with each other.

It should be noted that, as shown in the accompanying drawings, sizes such as thickness, length, and width of various components and sizes such as overall thickness, length, and width of integrated devices in some embodiments of this application are merely for illustrative purposes and should not constitute any limitations on this application.

An embodiment of this application provides an electrochemical apparatus including a first housing, a second housing, a cell assembly, a fire extinguisher, and a first wire. The second housing and the first housing are arranged in a first direction, the second housing and the first housing are connected to each other to form an accommodating space, and the cell assembly, the fire extinguisher, and the first wire are disposed in the accommodating space. The second housing includes a first surface, where the first surface faces the first housing in the first direction. The fire extinguisher is connected to the first surface, and the fire extinguisher includes a first side, a second side, a third side, and a fourth side, where the first side and the third side are arranged in a second direction perpendicular to the first direction, the second side and the fourth side are arranged in a third direction perpendicular to the first direction and the second direction, the first side is connected to the second side and the fourth side, and the third side is connected to the second side and the fourth side. The first wire is connected to the first surface, the first wire and the cell assembly are arranged in the first direction, and the first wire includes a first part, a second part, and a third part, where the first part, the second part, and the third part are connected in sequence, the first part and the first side are arranged in the second direction, the second part and the second side are arranged in the third direction, the third part and the third side are arranged in the second direction, and the first part is connected to the first side.

In the electrochemical apparatus of this application, the fire extinguisher and the first wire are disposed on the first surface of the second housing, the first part of the first wire is arranged with the first side of the fire extinguisher, the second part is arranged with the second side, and the third part is arranged with the third side. This optimizes arrangement of the first wire and is conducive to enlarging a sensing range of the first wire without increasing the length of the first wire, so as to increase a response speed of the fire extinguisher to abnormal high temperatures or flames, thereby improving the safety performance of the electrochemical apparatus.

The following further describes some embodiments of this application with reference to the accompanying drawings.

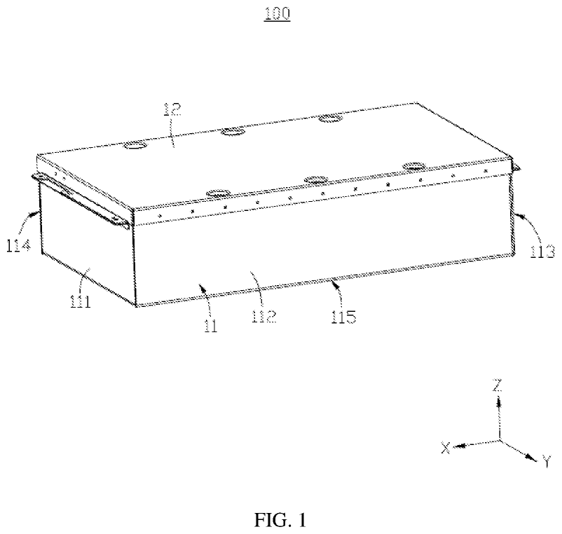

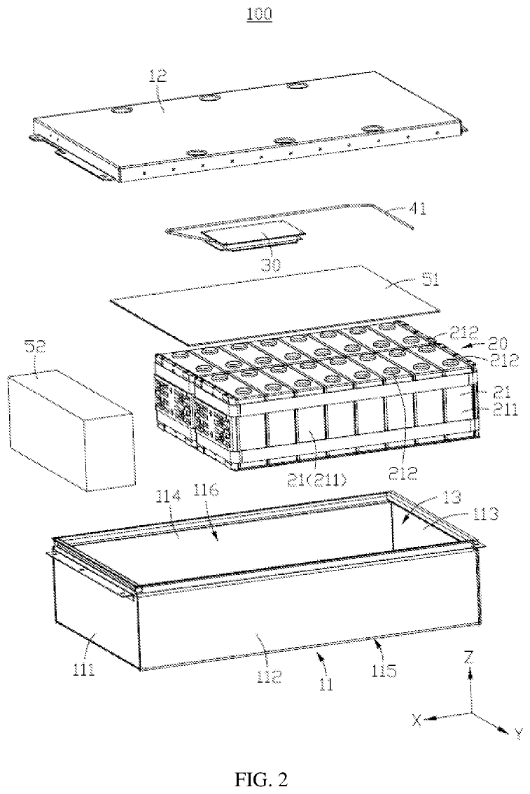

As shown in FIGS. 1 and 2, an embodiment of this application provides an electrochemical apparatus 100 including a first housing 11, a second housing 12, a cell assembly 20, a fire extinguisher 30, and a first wire 41. The second housing 12 and the first housing 11 are arranged in a first direction Z, the second housing 12 and the first housing 11 are connected to each other to form an accommodating space 13, and the cell assembly 20, the fire extinguisher 30, and the first wire 41 are disposed in the accommodating space 13.

In an embodiment, the first housing 11 includes a first wall 111, a second wall 112, a third wall 113, a fourth wall 114, and a fifth wall 115. The first wall 111 and the third wall 113 are arranged in a second direction X and both extend along the first direction Z and a third direction Y. The second wall 112 and the fourth wall 114 are arranged in the third direction Y and both extend along the first direction Z and the second direction X. The fifth wall 115 and the second housing 12 are arranged in the first direction Z and both extend along the second direction X and the third direction Y. The first wall 111 and the third wall 113 are both connected to the second wall 112 and the fourth wall 114. The fifth wall 115 is connected to the first wall 111, the second wall 112, the third wall 113, and the fourth wall 114. The first wall 111, the second wall 112, the third wall 113, the fourth wall 114, and the fifth wall 115 form a recess 116 with an opening facing the second housing 12. At least a portion of the cell assembly 20 is located in the recess 116. The second direction X is perpendicular to the first direction Z, and the third direction Y is perpendicular to the first direction Z and the second direction X.

In an embodiment, the electrochemical apparatus 100 further includes a circuit board 52, where the circuit board 52 is electrically connected to the cell assembly 20 and can be used to control charge and discharge of the cell assembly 20.

In an embodiment, the circuit board 52 is disposed in the recess 116. When viewed in the first direction Z, the circuit board 52 is located between the first wall 111 and the cell assembly 20, which is conducive to optimizing internal layout of the electrochemical apparatus 100, increasing internal space utilization of the electrochemical apparatus 100, and increasing energy density of the electrochemical apparatus 100.

In an embodiment, when viewed in the first direction Z, the circuit board 52 and the cell assembly 20 are arranged in the second direction X, and the first wire 41 is disposed crossing the circuit board 52 and the cell assembly 20 (this is not shown in the figure). This is conducive to increasing a response speed of the first wire 41 to abnormal high temperatures or fires of the circuit board 52 or the cell assembly 20.

In an embodiment, the circuit board 52 includes a BMS (Battery Management System, BMS for short) assembly, where the BMS assembly includes a plurality of electronic components. The plurality of electronic components can realize functions such as data acquisition, control, protection, communication, electric quantity calculation, signal transmission, and electric energy transmission of the cell assembly 20.

In an embodiment, the cell assembly 20 includes a plurality of cell units 21. All the cell units 21 are stacked along the second direction X and/or the third direction Y. In an embodiment, all the cell units 21 are connected in series. In an embodiment, all the cell units 21 are connected in parallel. In an embodiment, all the cell units 21 are connected in series-parallel.

In an embodiment, each cell unit 21 includes a cell body 211, an electrode assembly (not shown in the figure), and an electrode terminal 212. The electrode assembly is disposed in the cell body 211. A portion of the electrode terminal 212 is located in the cell body 211 and connected to the electrode assembly. A portion of the electrode terminal 212 extends out of the cell body 211. Different cell units 21 are electrically connected through the electrode terminal 212.

In an embodiment, each cell unit 21 includes two electrode terminals 212. One of the two electrode terminals 212 is a positive electrode terminal, and the other is a negative electrode terminal.

In an embodiment, the first housing 11 is made of metal, which is conducive to enhancing the structural strength of the first housing 11 and reducing the risk of deformation or damage to the first housing 11. Optionally, the first housing 11 is obtained by welding after bending in a sheet metal process.

In an embodiment, the first housing 11 is made of plastic, which is conducive to reducing the weight of the electrochemical apparatus 100. Optionally, the first housing 11 is formed by melting and then curing plastic using an injection molding device.

In an embodiment, the second housing 12 is made of metal, which is conducive to enhancing the structural strength of the second housing 12 and reducing the risk of deformation or damage to the second housing 12. Optionally, the second housing 12 is obtained by welding after bending in a sheet metal process.

In an embodiment, the second housing 12 is made of plastic, which is conducive to reducing the weight of the electrochemical apparatus 100. Optionally, the second housing 12 is formed by curing and then melting plastic using an injection molding device.

In an embodiment, the first housing 11 and the second housing 12 are fixedly connected through bolts and nuts (not shown in the figure), which is conducive to simplifying an assembly process of the first housing 11 and the second housing 12 and improving assembly efficiency of the electrochemical apparatus 100.

As shown in FIGS. 2, 3, and 4, the second housing 12 includes a first surface 121, where the first surface 121 faces the first housing 11 in the first direction Z. The fire extinguisher 30 and the first wire 41 are connected to the first surface 121, and the fire extinguisher 30 and the first wire 41 are both arranged with the cell assembly 20 in the first direction Z.

In an embodiment, the fire extinguisher 30 includes but is not limited to an aerosol fire extinguisher. The working principle of the aerosol fire extinguisher is to combine an efficient gas-generating agent with a fire-extinguishing aerosol generator, so as to release efficient fire-extinguishing particles through chemical reactions to extinguish flames.

The fire extinguisher 30 includes a first side 31, a second side 32, a third side 33, and a fourth side 34. The first side 31 and the third side 33 are arranged in the second direction X and both extend along the third direction Y. The second side 32 and the fourth side 34 are arranged in the third direction Y and both extend along the second direction X. The first side 31 is connected to the second side 32 and the fourth side 34. The third side 33 is connected to the second side 32 and the fourth side 34.

The first wire 41 includes a first part 411, a second part 412, and a third part 413, where the first part 411, the second part 412, and the third part 413 are connected in sequence. A portion of the first part 411 is opposite to the first side 31 in the second direction X. A portion of the second part 412 is opposite to the second side 32 in the third direction Y. A portion of the third part 413 is opposite to the third side 33 in the second direction X. The first part 411 is connected to the first side 31.

In the electrochemical apparatus 100 according to some embodiments of this application, the fire extinguisher 30 and the first wire 41 are disposed on the first surface 121 of the second housing 12, the portion of the first part 411 is opposite to the first side 31 of the fire extinguisher 30 in the second direction, the portion of the second part 412 is opposite to the second side 32 in the third direction Y, and the portion of the third part 413 is opposite to the third side 33 in the second direction X. This is conducive to enlarging a sensing range of the first wire 41 without increasing the length of the first wire 41, so as to increase the response speed of the fire extinguisher 30 to abnormal high temperatures or flames, thereby improving the safety performance of the electrochemical apparatus 100.

In an embodiment, when viewed in the second direction X, a portion of the first part 411 is apart from the third side 33, and a portion of the third part 413 is apart from the third side 33; and when viewed in the third direction Y, a portion of the second part 412 is apart from the second side 32. Arrangement of the first wire 41 is adjusted such that multiple parts of the first wire 41 are apart from the fire extinguisher 30. This is conducive to enlarging the sensing range of the first wire 41, so as to increase the response speed of the fire extinguisher 30 to abnormal high temperatures or flames, thereby improving the safety performance of the electrochemical apparatus 100.

In an embodiment, the first wire 41 is a heat-sensitive wire. In a case of abnormal high temperature or fire in the electrochemical apparatus 100, the heat-sensitive wire is ignited and the flame spreads to the fire extinguisher 30 along the wire, thus triggering the fire extinguisher 30 to extinguish the fire.

In an embodiment, the first wire 41 is a temperature sensing wire. In a case of abnormal high temperature or fire in the electrochemical apparatus 100, when sensing that an ambient temperature rises to its trigger temperature, the temperature sensing wire transmits an electrical signal to the fire extinguisher 30 along the wire, thus triggering the fire extinguisher 30 to extinguish the fire.

In another embodiment, in the first direction Z, the circuit board 52 is located between the cell assembly 20 and the fire extinguisher 30 (this is not shown in the figure); and the first wire 41, the circuit board 52, and the cell assembly 20 are arranged in the first direction Z. This is conducive to increasing the response speed of the first wire 41 to abnormal high temperatures or fires of the circuit board 52, is also conducive to increasing the response speed of the first wire 41 to abnormal high temperatures or fires of the cell assembly 20 through the circuit board 52, thus improving the safety performance of the electrochemical apparatus 100, and is further conducive to reducing the length of the electrochemical apparatus 100 in the second direction X.

In an embodiment, the electrochemical apparatus 100 further includes a first structural member 51, where the first structural member 51 is disposed in the accommodating space 13, and at least a portion of the first structural member 51 is located between the cell assembly 20 and the second housing 12 in the first direction Z and connected to the cell assembly 20 and the second housing 12. In the first direction Z, the fire extinguisher 30 and the first wire 41 are located on a side of the first structural member 51 facing away from the cell assembly 20. The provision of the first structural member 51 is conducive to achieving filling and protection and reducing the risk of collision between the fire extinguisher, the first wire 41, the second housing 12, and the cell assembly 20, thereby improving vibration-resistant performance of the electrochemical apparatus 100.

In an embodiment, the first structural member 51 can also achieve insulating protection, reducing the risk of short circuit in the cell assembly 20.

In an embodiment, the material of the first structural member 51 includes but is not limited to either of foam or a plastic plate, and the plastic plate includes either of a PC/ABS plate or a polytetrafluoroethylene plate.

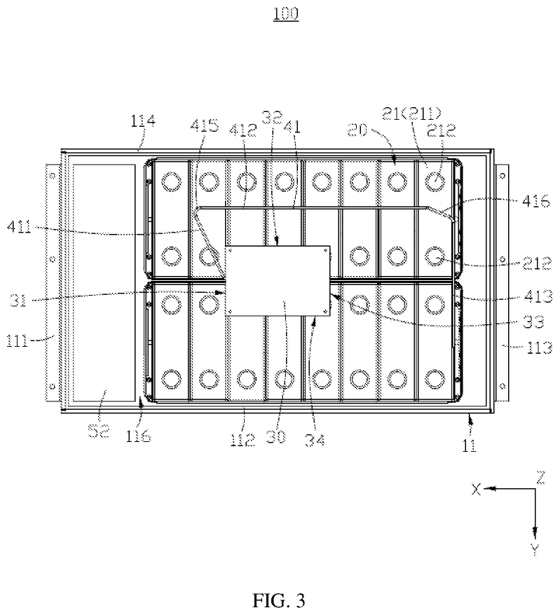

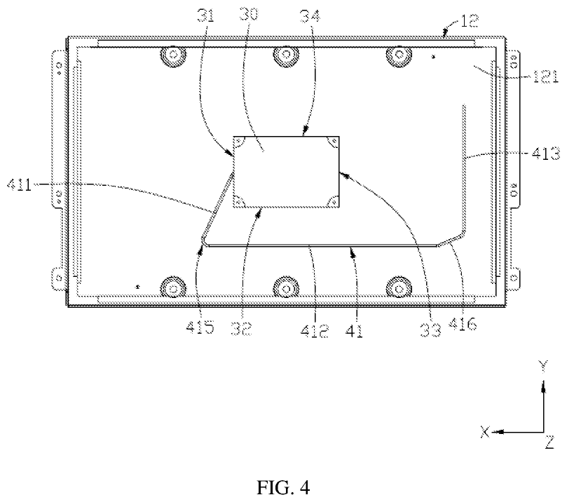

As shown in FIGS. 3 and 4, in an embodiment, when viewed in the first direction Z, a projection of the fire extinguisher 30 is located in a projection of the cell assembly 20 and is close to the center of the projection of the cell assembly 20. When the fire extinguisher 30 is triggered to extinguish fire, the fire extinguisher 30 is located at the center of the cell assembly 20. This is conducive to improving the fire extinguishing effect of the fire extinguisher 30 in various regions and shortening the fire extinguishing time of the fire extinguisher 30, thereby improving the safety performance of the electrochemical apparatus 100.

In an embodiment, when viewed in the first direction Z, a projection of the first wire 41 is located in the projection of the cell assembly 20. This is conducive to enlarging the sensing range of the first wire 41 without wasting the length of the first wire 41, thereby reducing costs and increasing the response speed for fire extinction.

In an embodiment, when viewed in the first direction Z, the second part 412 is apart from the second side 32, and the third part 413 is apart from the third side 33, so that the first wire 41 surrounds the fire extinguisher 30. This is conducive to enlarging the sensing range of the first wire 41, so as to increase the response speed of the fire extinguisher 30 to abnormal high temperatures or flames, thereby improving the safety performance of the electrochemical apparatus 100.

In an embodiment, the first wire 41 further includes a first bent part 415, where the first part 411 and the second part 412 are connected through the first bent part 415. The provision of the first bent part 415 is conducive to reducing the risk of damage or even fracture of the first wire 41 due to local stress concentration, thereby improving the safety performance of the electrochemical apparatus 100.

In an embodiment, when viewed in the first direction Z, the first bent part 415 is an arc-shaped structure, and the first part 411 and the second part 412 are both smoothly connected to the first bent part 415. This is conducive to further reducing the risk of damage or even fracture of the first wire 41 due to local stress concentration, thereby improving the safety performance of the electrochemical apparatus 100.

In an embodiment, when viewed in the first direction Z, the first bent part 415 exceeds the first side 31 in the second direction X; when viewed in the second direction X, the first bent part 415 is apart from the fire extinguisher 30; and when viewed in the third direction Y, the first bent part 415 is apart from the fire extinguisher 30. This is conducive to enlarging the sensing range of the first wire 41, so as to increase the response speed of the fire extinguisher 30 to abnormal high temperatures or flames, thereby improving the safety performance of the electrochemical apparatus 100.

In an embodiment, the first wire 41 further includes a third bent part 416, where the second part 412 and the third part 413 are connected through the third bent part 416. The provision of the third bent part 416 is conducive to reducing the risk of damage or even fracture of the first wire 41 due to local stress concentration, thereby improving the safety performance of the electrochemical apparatus 100.

In an embodiment, when viewed in the first direction Z, the third bent part 416 exceeds the third side 33 in an opposite direction of the second direction X, and the third bent part 416 exceeds the second side 32 in an opposite direction of the third direction Y. This is conducive to enlarging the sensing range of the first wire 41, so as to increase the response speed of the fire extinguisher 30 to abnormal high temperatures or flames, thereby improving the safety performance of the electrochemical apparatus 100.

In an embodiment, when viewed in the first direction Z, an end portion of the third part 413 far away from the second part 412 exceeds the third side 33 in the opposite direction of the second direction X, and the end portion of the third part 413 far away from the second part 412 exceeds the fourth side 34 in the third direction Y. This is conducive to enlarging the sensing range of the first wire 41, so as to increase the response speed of the fire extinguisher 30 to abnormal high temperatures or flames, thereby improving the safety performance of the electrochemical apparatus 100.

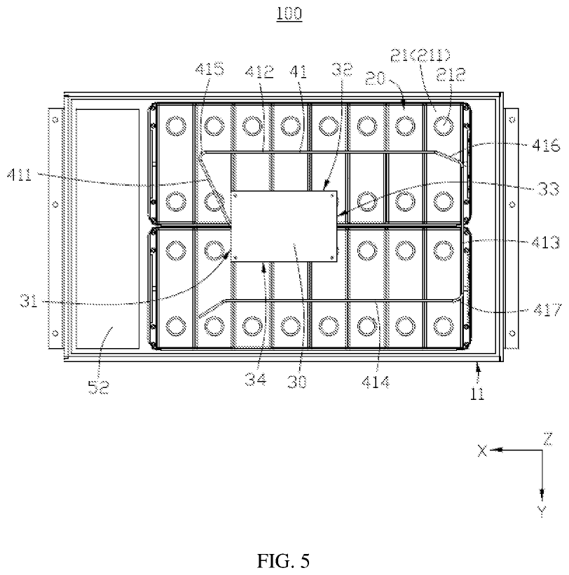

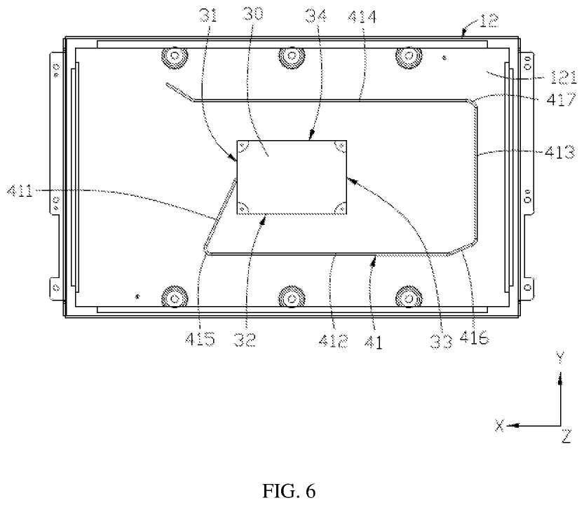

As shown in FIGS. 5 and 6, in an embodiment, the first wire 41 further includes a fourth part 414, where the fourth part 414 is connected to the third part 413, and a portion of the fourth part 414 is opposite to the fourth side 34 in the third direction Y. The provision of the fourth part 414 is conducive to enlarging the sensing range of the first wire 41, so as to increase the response speed of the fire extinguisher 30 to abnormal high temperatures or flames, thereby improving the safety performance of the electrochemical apparatus 100.

In an embodiment, when viewed in the first direction Z, the fourth part 414 is apart from the fourth side 34, which is conducive to enlarging the sensing range of the first wire 41, so as to increase the response speed of the fire extinguisher 30 to abnormal high temperatures or flames, thereby improving the safety performance of the electrochemical apparatus 100.

In an embodiment, the first wire 41 further includes a fourth bent part 417, where the third part 413 and the fourth part 414 are connected through the fourth bent part 417. The provision of the fourth bent part 417 is conducive to reducing the risk of damage or even fracture of the first wire 41 due to local stress concentration, thereby improving the safety performance of the electrochemical apparatus 100.

In an embodiment, when viewed in the first direction Z, the fourth bent part 417 exceeds the third side 33 in the opposite direction of the second direction X, and the fourth bent part 417 exceeds the fourth side 34 in the third direction Y. This is conducive to enlarging the sensing range of the first wire 41, so as to increase the response speed of the fire extinguisher 30 to abnormal high temperatures or flames, thereby improving the safety performance of the electrochemical apparatus 100.

In an embodiment, when viewed in the first direction Z, an end portion of the fourth part 414 far away from the fourth bent part 417 exceeds the first side 31 in the second direction X, and the end portion of the fourth part 414 far away from the fourth bent part 417 exceeds the fourth side 34 in the third direction Y. This is conducive to enlarging the sensing range of the first wire 41, so as to increase the response speed of the fire extinguisher 30 to abnormal high temperatures or flames, thereby improving the safety performance of the electrochemical apparatus 100.

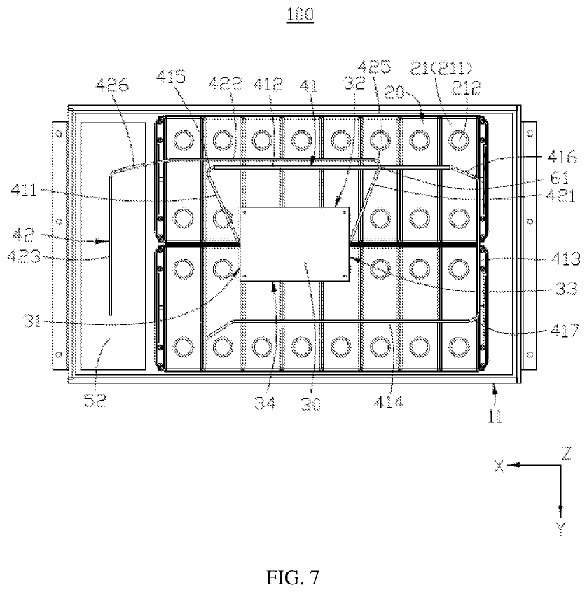

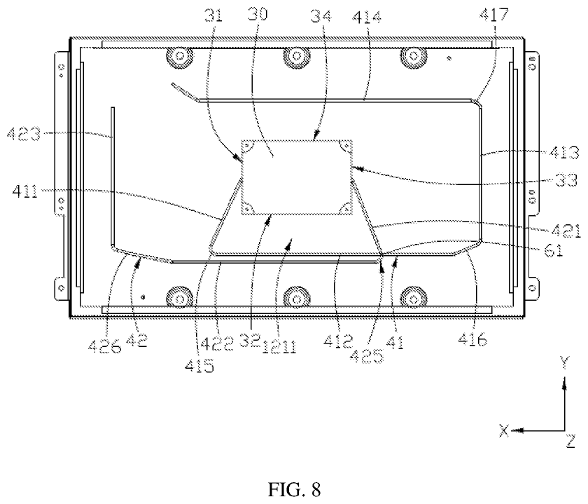

As shown in FIGS. 7 and 8, in an embodiment, the electrochemical apparatus 100 further includes a second wire 42, where the second wire 42 is disposed in the accommodating space 13 and connected to the first surface 121, and the second wire 42 and the cell assembly 20 are arranged in the first direction Z.

The second wire 42 includes a fifth part 421, a sixth part 422, and a seventh part 423, where the fifth part 421, the sixth part 422, and the seventh part 423 are connected in sequence, a portion of the fifth part 421 is opposite to the third side 33 in the second direction X, a portion of the sixth part 422 is opposite to the second side 32 in the third direction Y, a portion of the seventh part 423 is opposite to the first side 31 in the second direction X, and the fifth part 421 is connected to the third side 33.

The second wire 42 is provided, and the second wire 42 cooperates with the first wire 41 to sense different regions of the electrochemical apparatus 100, which is conducive to increasing the response speed of the fire extinguisher 30 to abnormal high temperatures or flames, thereby improving the safety performance of the electrochemical apparatus 100.

In an embodiment, when viewed in the first direction Z, a projection of the seventh part 423 overlaps a projection of the circuit board 52, and in a case of abnormal high temperature or fire in the circuit board 52, the seventh part 423 of the second wire 42 can be ignited to trigger the fire extinguisher 30 to extinguish the fire. This is conducive to improving the safety performance of the electrochemical apparatus 100. Optionally, when viewed in the first direction Z, the projection of the seventh part 423 is located in the projection of the circuit board 52.

In an embodiment, the second wire 42 is a heat-sensitive wire. In a case of abnormal high temperature or fire in the electrochemical apparatus 100, the heat-sensitive wire is ignited and the flame spreads to the fire extinguisher 30 along the wire, thus triggering the fire extinguisher 30 to extinguish the fire.

In an embodiment, the second wire 42 is a temperature sensing wire. In a case of abnormal high temperature or fire in the electrochemical apparatus 100, when sensing that an ambient temperature rises to its trigger temperature, the temperature sensing wire transmits an electrical signal to the fire extinguisher 30 along the wire, thus triggering the fire extinguisher 30 to extinguish the fire.

In an embodiment, when viewed in the first direction Z, a projection of the second wire 42 is located in the projection of the cell assembly 20. This is conducive to enlarging a sensing range of the second wire 42 without wasting the length of the second wire 42, thereby reducing costs and increasing the response speed for fire extinction.

In an embodiment, when viewed in the first direction Z, the sixth part 422 is apart from the second side 32, and the seventh part 423 is apart from the first side 31, so that the second wire 42 surrounds the fire extinguisher 30. This is conducive to enlarging the sensing range of the second wire 42, so as to increase the response speed of the fire extinguisher 30 to abnormal high temperatures or flames, thereby improving the safety performance of the electrochemical apparatus 100.

In an embodiment, the second wire 42 further includes a second bent part 425, where the fifth part 421 and the sixth part 422 are connected through the second bent part 425. The provision of the second bent part 425 is conducive to reducing the risk of damage or even fracture of the second wire 42 due to local stress concentration, thereby improving the safety performance of the electrochemical apparatus 100.

In an embodiment, when viewed in the first direction Z, the second bent part 425 is an arc-shaped structure, and the first part 411 and the second part 412 are both smoothly connected to the second bent part 425. This is conducive to further reducing the risk of damage or even fracture of the second wire 42 due to local stress concentration, thereby improving the safety performance of the electrochemical apparatus 100.

In an embodiment, when viewed in the first direction Z, the second bent part 425 exceeds the third side 33 in the opposite direction of the second direction X; when viewed in the second direction, the second bent part 425 is apart from the fire extinguisher 30; and when viewed in the third direction, the second bent part 425 is apart from the fire extinguisher 30. This is conducive to enlarging the sensing range of the second wire 42, so as to increase the response speed of the fire extinguisher 30 to abnormal high temperatures or flames, thereby improving the safety performance of the electrochemical apparatus 100.

In an embodiment, the second wire 42 further includes a fifth bent part 426, where the sixth part 422 and the seventh part 423 are connected through the fifth bent part 426. The provision of the fifth bent part 426 is conducive to reducing the risk of damage or even fracture of the second wire 42 due to local stress concentration, thereby improving the safety performance of the electrochemical apparatus 100.

In an embodiment, when viewed in the first direction Z, the fifth bent part 426 exceeds the first side 31 in the second direction X, and the fifth bent part 426 exceeds the second side 32 in the opposite direction of the third direction Y. This is conducive to enlarging the sensing range of the second wire 42, so as to increase the response speed of the fire extinguisher 30 to abnormal high temperatures or flames, thereby improving the safety performance of the electrochemical apparatus 100.

In an embodiment, when viewed in the first direction Z, an end portion of the seventh part 423 far away from the fifth bent part 426 exceeds the first side 31 in the second direction X, and the end portion of the seventh part 423 far away from the fifth bent part 426 exceeds the fourth side 34 in the third direction Y. This is conducive to enlarging the sensing range of the second wire 42, so as to increase the response speed of the fire extinguisher 30 to abnormal high temperatures or flames, thereby improving the safety performance of the electrochemical apparatus 100.

In an embodiment, when viewed in the first direction Z, a projection of the fifth bent part 426 overlaps the projection of the circuit board 52, which is conducive to enlarging the sensing range of the second wire 42, so as to increase the response speed of the fire extinguisher 30 to abnormal high temperatures or flames, thereby improving the safety performance of the electrochemical apparatus 100.

In an embodiment, when viewed in the first direction Z, at least a portion of the first wire 41 overlaps at least a portion of the second wire 42. This is conducive to reducing sensing blind regions of the first wire 41 and the second wire 42 and enlarging the sensing ranges of the first wire 41 and the second wire 42, so as to increase the response speed of the fire extinguisher 30 to abnormal high temperatures or flames, thereby improving the safety performance of the electrochemical apparatus 100.

In an embodiment, a portion of the second part 412 and a portion of the sixth part 422 are opposite and apart from each other in the third direction Y, which is conducive to enlarging the sensing ranges of the first wire 41 and the second wire 42, so as to increase the response speed of the fire extinguisher 30 to abnormal high temperatures or flames, thereby improving the safety performance of the electrochemical apparatus 100. Optionally, a portion of the second part 412 is located between the second side 32 and the sixth part 422.

In an embodiment, in the third direction Y, the second part 412 and the sixth part 422 are apart from each other but in close proximity. When either of the second part 412 or the sixth part 422 is ignited by flame, a distance between the second part 412 and the sixth part 422 in the third direction Y allows the other one to be also ignited, so that the first wire 41 and the second wire 42 are simultaneously ignited and the flame can spread to the fire extinguisher 30 in the shortest path. This is conducive to increasing the response speed of the fire extinguisher 30 to abnormal high temperatures or flames, thereby improving the safety performance of the electrochemical apparatus 100. The second part 412 and the sixth part 422 being in close proximity in the third direction Y refers to that the distance between the second part 412 and the sixth part 422 in the third direction Y is greater than 0 and less than or equal to 2 mm.

In an embodiment, when viewed in the first direction Z, the second part 412 and the fifth part 421 intersect to form a first intersection point 61, which is conducive to enlarging the sensing ranges of the first wire 41 and the second wire 42, so as to increase the response speed of the fire extinguisher 30 to abnormal high temperatures or flames, thereby improving the safety performance of the electrochemical apparatus 100.

In an embodiment, when viewed in the second direction X, the first intersection point 61 is apart from the third side 33; and when viewed in the third direction Y, the first intersection point 61 is apart from the second side 32. The adjustment of a position of the first intersection point 61 is conducive to reducing the sensing blind regions of the first wire 41 and the second wire 42 and enlarging the sensing ranges of the first wire 41 and the second wire 42, so as to increase the response speed of the fire extinguisher 30 to abnormal high temperatures or flames, thereby improving the safety performance of the electrochemical apparatus 100.

In an embodiment, when viewed in the first direction Z, the first surface 121 includes a first region 1211, where the first region 1211 is enclosed by the first wire 41, the second wire 42, the first side 31, the second side 32, and the third side 33, the first region 1211 is apart from the fourth side 34, and the first region 1211 connects to the second side 32. In a case of abnormal high temperature or fire in a region corresponding to the first region 1211 on the cell assembly 20, after the first wire 41 and/or the second wire 42 forming the first region 1211 are ignited, the flame can spread to the fire extinguisher 30 along the wire in the shortest path, increasing the response speed of the fire extinguisher 30 to abnormal high temperatures or flames, thereby improving the safety performance of the electrochemical apparatus 100.

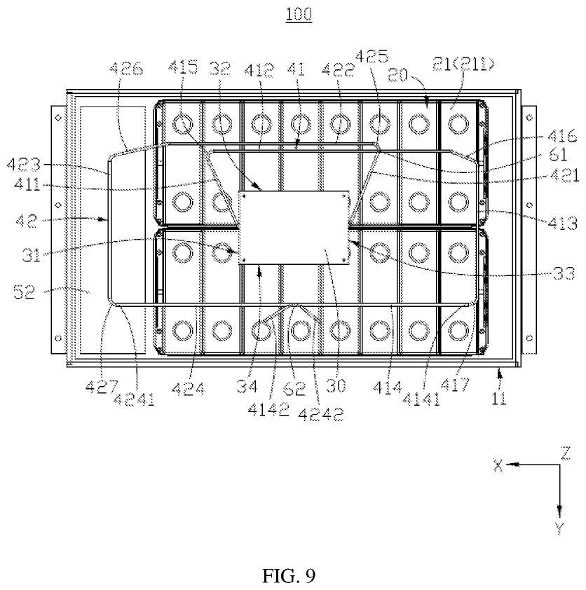

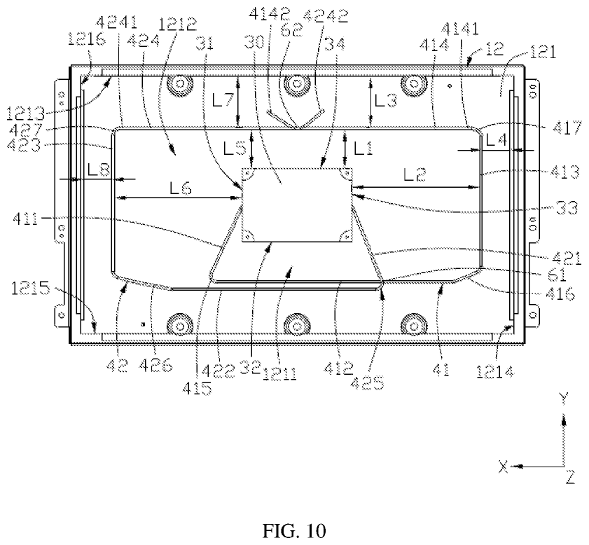

Referring to FIGS. 9 and 10, for structures which are the same as those in the foregoing embodiments, same reference signs are given to such structures in FIGS. 9 and 10, and the detailed description thereof will be omitted.

As shown in FIGS. 9 and 10, in an embodiment, the second wire 42 further includes an eighth part 424, where the eighth part 424 is connected to the seventh part 423, and a portion of the eighth part 424 is opposite to the fourth side 34 in the third direction Y. The provision of the eighth part 424 is conducive to enlarging the sensing range of the second wire 42, so as to increase the response speed of the fire extinguisher 30 to abnormal high temperatures or flames, thereby improving the safety performance of the electrochemical apparatus 100.

In an embodiment, when viewed in the first direction Z, the eighth part 424 is apart from the fourth side 34, which is conducive to enlarging the sensing range of the second wire 42, so as to increase the response speed of the fire extinguisher 30 to abnormal high temperatures or flames, thereby improving the safety performance of the electrochemical apparatus 100.

In an embodiment, the second wire 42 further includes a sixth bent part 427, where the seventh part 423 and the eighth part 424 are connected through the sixth bent part 427. The provision of the sixth bent part 427 is conducive to reducing the risk of damage or even fracture of the second wire 42 due to local stress concentration, thereby improving the safety performance of the electrochemical apparatus 100.

In an embodiment, when viewed in the first direction Z, the sixth bent part 427 exceeds the first side 31 in the second direction X, and the sixth bent part 427 exceeds the fourth side 34 in the third direction Y. This is conducive to enlarging the sensing range of the second wire 42, so as to increase the response speed of the fire extinguisher 30 to abnormal high temperatures or flames, thereby improving the safety performance of the electrochemical apparatus 100.

In an embodiment, when viewed in the first direction Z, a projection of the eighth part 424 overlaps the projection of the circuit board 52, and in a case of abnormal high temperatures or fires in the circuit board 52, the eighth part 424 of the second wire 42 can be ignited to trigger the fire extinguisher 30 to extinguish the fire. This is conducive to improving the safety performance of the electrochemical apparatus 100.

In an embodiment, when viewed in the first direction Z, a projection of the sixth bent part 427 is located in the projection of the circuit board 52, which is conducive to enlarging the sensing range of the second wire 42, so as to increase the response speed of the fire extinguisher 30 to abnormal high temperatures or flames, thereby improving the safety performance of the electrochemical apparatus 100.

In an embodiment, when viewed in the first direction Z, the fourth part 414 and the eighth part 424 intersect, and an intersection region of the fourth part 414 and the eighth part 424 and the fourth side 34 are arranged in the third direction Y. This is conducive to reducing the sensing blind regions of the first wire 41 and the second wire 42 and enlarging the sensing ranges of the first wire 41 and the second wire 42, so as to increase the response speed of the fire extinguisher 30 to abnormal high temperatures or flames, thereby improving the safety performance of the electrochemical apparatus 100.

In an embodiment, the fourth part 414 and the eighth part 424 intersect to form a second intersection point 62, where the second intersection point 62 is opposite to the fourth side 34 in the third direction Y. This is conducive to spreading of flames on the first wire 41 and the second wire 42 to the fire extinguisher 30 in the shortest path when either of the first wire 41 or the second wire 42 is ignited by flame, so as to increase the response speed of the fire extinguisher 30 to abnormal high temperatures or flames, thereby improving the safety performance of the electrochemical apparatus 100.

In an embodiment, the fourth part 414 includes a first end portion 4141 and a second end portion 4142, where the first end portion 4141 is connected to the third part 413 through the fourth bent part 417, in the second direction X, the first end portion 4141 is closer to the third part 413 than the second end portion 4142, and the second intersection point 62 is located between the first end portion 4141 and the second end portion 4142. This is conducive to enlarging the sensing range of the first wire 41, so as to increase the response speed of the fire extinguisher 30 to abnormal high temperatures or flames, thereby improving the safety performance of the electrochemical apparatus 100.

In an embodiment, the eighth part 424 includes a third end portion 4241 and a fourth end portion 4242, where the third end portion 4241 is connected to the seventh part 423 through the sixth bent part 427, in the second direction X, the third end portion 4241 is closer to the seventh part 423 than the fourth end portion 4242, and the second intersection point 62 is located between the third end portion 4241 and the fourth end portion 4242. This is conducive to enlarging the sensing range of the second wire 42, so as to increase the response speed of the fire extinguisher 30 to abnormal high temperatures or flames, thereby improving the safety performance of the electrochemical apparatus 100.

In an embodiment, when viewed in the first direction Z, the first surface 121 includes a second region 1212, where the second region 1212 is enclosed by the first wire 41, the second wire 42, the first side 31, the fourth side 34, and the third side 33, the second region 1212 is apart from the second side 32, and the second region 1212 connects to the fourth side 34. When viewed in the first direction Z, the second region 1212 has a larger area than the first region 1211, which is conducive to enlarging the sensing ranges of the first wire 41 and the second wire 42, so as to increase the response speed of the fire extinguisher 30 to abnormal high temperatures or flames, thereby improving the safety performance of the electrochemical apparatus 100.

In an embodiment, length of the first housing 11 in the second direction X is greater than length of the first housing 11 in the third direction Y, and length of the second housing 12 in the second direction X is greater than length of the second housing 12 in the third direction Y.

In an embodiment, a length of the fourth side 34 in the second direction X is greater than a length of the third side 33 in the third direction Y. In the third direction Y, a minimum distance between the fourth part 414 and the fourth side 34 is a first distance L1, and in the second direction X, a minimum distance between the third part 413 and the third side 33 is a second distance L2, where under a condition that the second housing 12 has a large length in the second direction X, the first distance L1 is less than the second distance L2. This is conducive to enlarging the sensing range of the first wire 41 and allowing the first wire 41 to sense a larger potential ignition region, so as to increase the response speed of the fire extinguisher 30 to abnormal high temperatures or flames, thereby improving the safety performance of the electrochemical apparatus 100.

In an embodiment, the first surface 121 has a fifth side 1213 and a sixth side 1214 connected to each other, where the fifth side 1213 extends along the second direction X and is opposite to the fourth side 34 in the third direction Y, and the sixth side 1214 extends along the third direction Y and is opposite to the third side 33 in the second direction X. In the third direction Y, a minimum distance between the fourth part 414 and the fifth side 1213 is a third distance L3, and in the second direction X, a minimum distance between the third part 413 and the sixth side 1214 is a fourth distance L4, where the third distance L3 is greater than the fourth distance L4. This is conducive to enlarging a portion (as shown in FIG. 9) of the first wire 41 in the projection of the cell assembly 20 in the first direction Z, so as to increase the response speed of the fire extinguisher 30 to abnormal high temperatures or flames, thereby improving the safety performance of the electrochemical apparatus 100.

In an embodiment, in the third direction Y, a minimum distance between the eighth part 424 and the fourth side 34 is a fifth distance L5, and in the second direction X, a minimum distance between the seventh part 423 and the first side 31 is a sixth distance L6, where under a condition that the second housing 12 has a large length in the second direction X, the fifth distance L5 is less than the sixth distance L6. This is conducive to enlarging the sensing range of the second wire 42 and allowing the second wire 42 to sense a larger potential ignition region, so as to increase the response speed of the fire extinguisher 30 to abnormal high temperatures or flames, thereby improving the safety performance of the electrochemical apparatus 100.

In an embodiment, the first surface 121 has a seventh side 1215 and an eighth side 1216 connected to each other, where the seventh side 1215 extends along the second direction X and is arranged with the second side 32 in the third direction Y, the eighth side 1216 extends along the third direction Y and is arranged with the first side 31 in the second direction X, the seventh side 1215 is connected to the sixth side 1214, and the eighth side 1216 is connected to the fifth side 1213. In the third direction Y, a minimum distance between the eighth part 424 and the fifth side 1213 is a seventh distance L7, and in the second direction X, a minimum distance between the seventh part 423 and the eighth side 1216 is an eighth distance L8, where the seventh distance L7 is greater than the eighth distance L8. This is conducive to enlarging a portion (as shown in FIG. 9) of the second wire 42 in the projection of the cell assembly 20 in the first direction Z, so as to increase the response speed of the fire extinguisher 30 to abnormal high temperatures or flames, thereby improving the safety performance of the electrochemical apparatus 100.

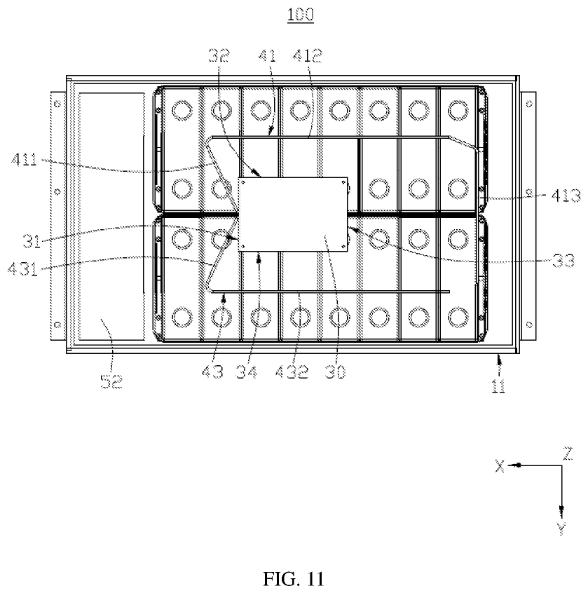

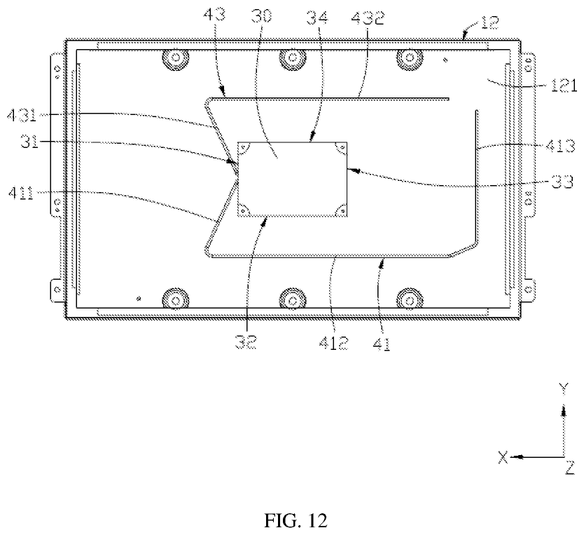

As shown in FIGS. 11 and 12, in an embodiment, the electrochemical apparatus 100 further includes a third wire 43, where the third wire 43 is disposed in the accommodating space 13 and connected to the first surface 121, and the third wire 43 and the cell assembly 20 are arranged in the first direction Z.

The third wire 43 includes a first section 431 and a second section 432 connected in sequence, where a portion of the first section 431 is opposite to the first side 31 in the second direction X, a portion of the second section 432 is opposite to the fourth side 34 in the third direction Y, and the first section 431 is connected to the first side 31.

The third wire 43 is provided and the third wire 43 cooperates with the first wire 41 to sense different regions of the electrochemical apparatus 100, which is conducive to increasing the response speed of the fire extinguisher 30 to abnormal high temperatures or flames, thereby improving the safety performance of the electrochemical apparatus 100.

In an embodiment, the third wire 43 is a heat-sensitive wire. In a case of abnormal high temperatures or fires in the electrochemical apparatus 100, the heat-sensitive wire is ignited and the flame spreads to the fire extinguisher 30 along the wire, thus triggering the fire extinguisher 30 to extinguish the fire.

In an embodiment, the third wire 43 is a temperature sensing wire. In a case of abnormal high temperatures or fires in the electrochemical apparatus 100, when sensing that an ambient temperature rises to its trigger temperature, the temperature sensing wire transmits an electrical signal to the fire extinguisher 30 along the wire, thus triggering the fire extinguisher 30 to extinguish the fire.

In an embodiment, when viewed in the first direction Z, the first section 431 is apart from the first part 411.

In an embodiment, when viewed in the first direction Z, the second section 432 is apart from the third part 413.

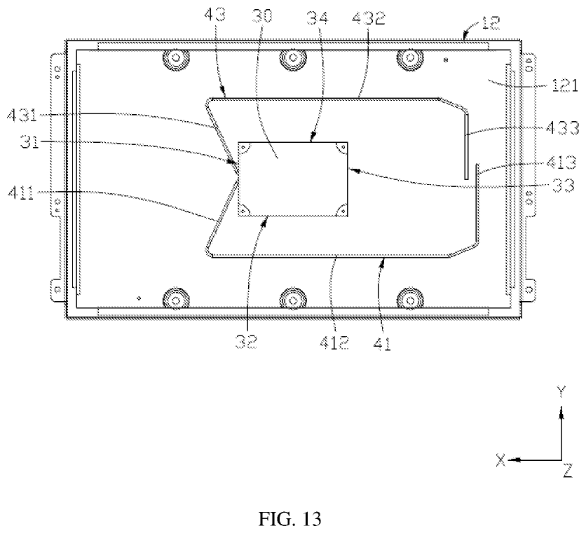

As shown in FIG. 13, in an embodiment, the third wire 43 further includes a third section 433, where the third section 433 is connected to the second section 432, and a portion of the third section 433 is opposite to the third side 33 in the second direction X. This is conducive to enlarging the sensing range of the third wire 43, so as to increase the response speed of the fire extinguisher 30 to abnormal high temperatures or flames, thereby improving the safety performance of the electrochemical apparatus 100.

In an embodiment, when viewed in the first direction Z, the third part 413 is apart from the third section 433.

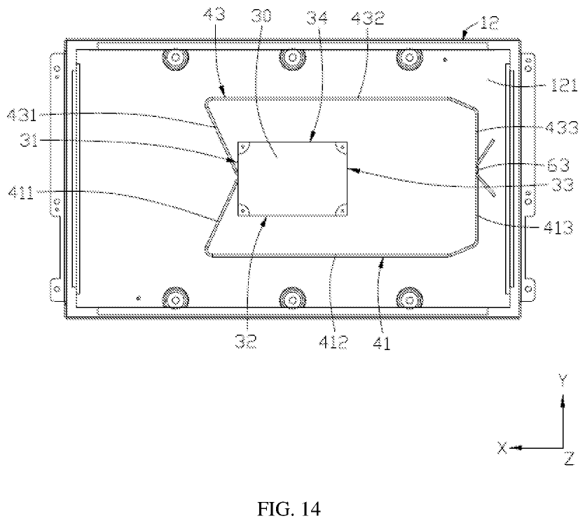

As shown in FIG. 14, in an embodiment, when viewed in the first direction Z, the third part 413 and the third section 433 intersect to form a third intersection point 63, the third intersection point 63 being opposite to the third side 33 in the second direction X. This is conducive to reducing the sensing blind regions of the third wire 43 and the first wire 41, so as to increase the response speed of the fire extinguisher 30 to abnormal high temperatures or flames, thereby improving the safety performance of the electrochemical apparatus 100.

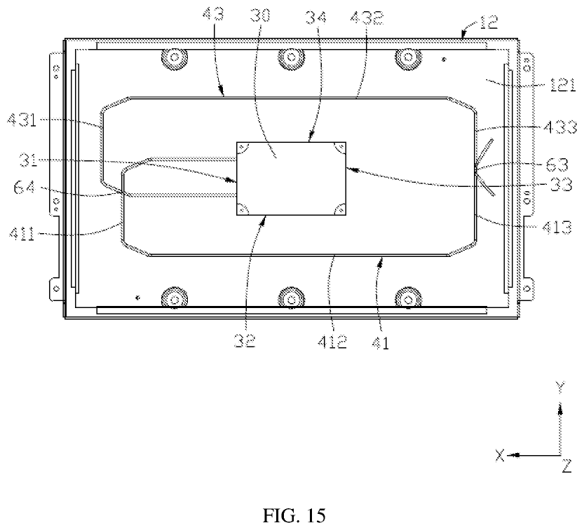

As shown in FIG. 15, in an embodiment, when viewed in the first direction Z, the first part 411 and the first section 431 intersect to form a fourth intersection point 64, the fourth intersection point 64 being opposite to the first side 31 in the second direction X. This is conducive to reducing the sensing blind regions of the third wire 43 and the first wire 41, so as to increase the response speed of the fire extinguisher 30 to abnormal high temperatures or flames, thereby improving the safety performance of the electrochemical apparatus 100.

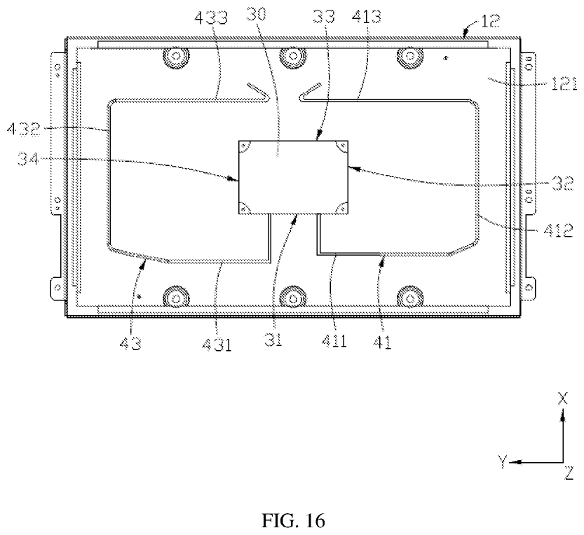

As shown in FIG. 16, in an embodiment, length of the first housing 11 in the second direction X is less than length of the first housing 11 in the third direction Y, and length of the second housing 12 in the second direction X is less than length of the second housing 12 in the third direction Y.

In an embodiment, when viewed in the first direction Z, the first part 411 is apart from the first section 431, and the third part 413 is apart from the third section 433.

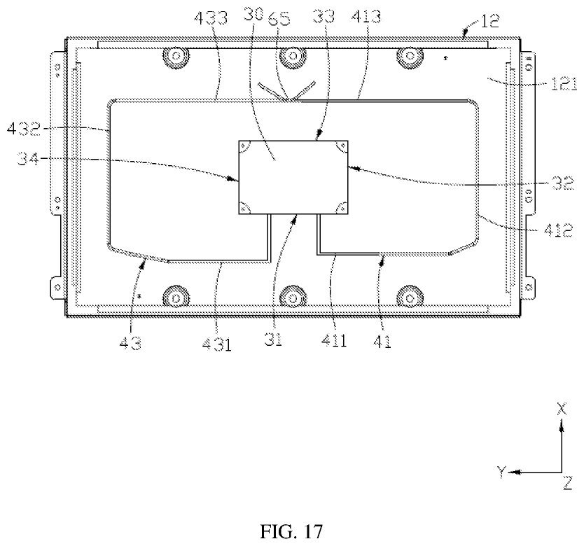

As shown in FIG. 17, in an embodiment, when viewed in the first direction Z, the first part 411 is apart from the first section 431, and the third part 413 and the third section 433 intersect to form a fifth intersection point 65, the fifth intersection point 65 being opposite to the third side 33 in the second direction X.

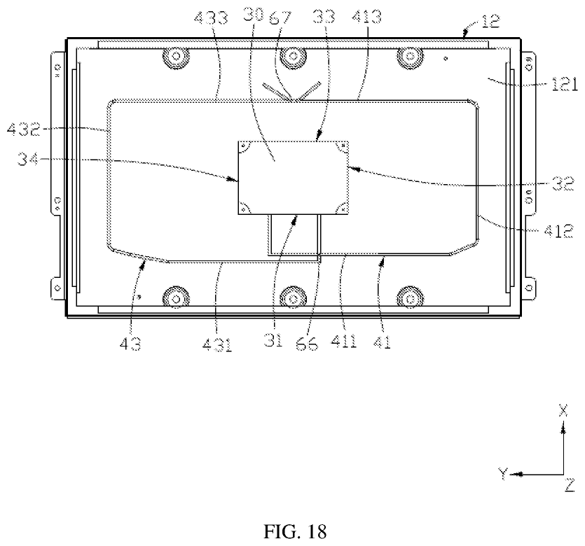

As shown in FIG. 18, in an embodiment, when viewed in the first direction Z, the first part 411 and the first section 431 intersect to form a sixth intersection point 66, the sixth intersection point 66 being opposite to the first side 31 in the second direction X, and the third part 413 and the third section 433 intersect to form a seventh intersection point 67, the seventh intersection point 67 being opposite to the third side 33 in the second direction X.

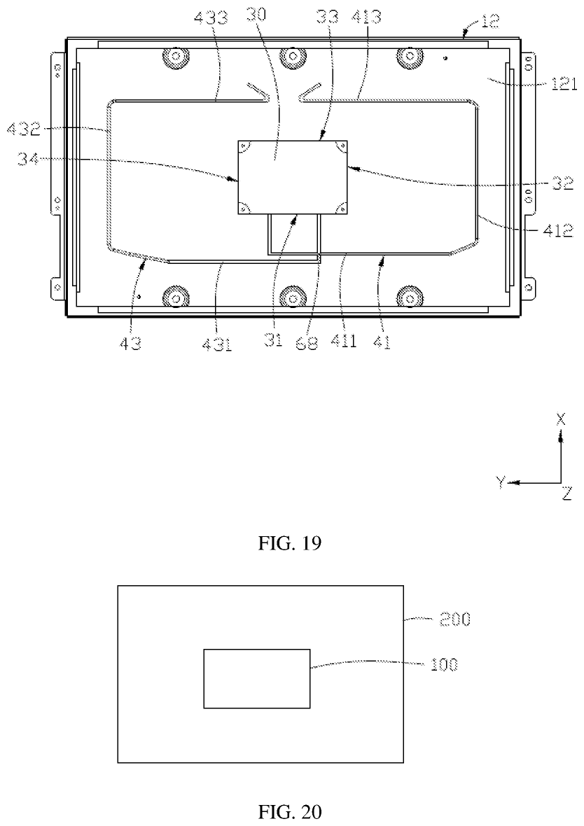

As shown in FIG. 19, in an embodiment, when viewed in the first direction Z, the first part 411 and the first section 431 intersect to form an eighth intersection point 68, the eighth intersection point 68 being opposite to the first side 31 in the second direction X, and the third part 413 is apart from the third section 433.

To sum up, in the electrochemical apparatus 100 of this application, the fire extinguisher 30 and the first wire 41 are disposed on the first surface 121 of the second housing 12, the first part 411 of the first wire 41 is arranged with the first side 31 of the fire extinguisher 30, the second part 412 is arranged with the second side 32, and the third part 413 is arranged with the third side 33. This optimizes arrangement of the first wire 41 and is conducive to enlarging the sensing range of the first wire 41 without increasing the length of the first wire 41, so as to increase a response speed of the fire extinguisher 30 to abnormal high temperatures or flames, thereby improving the safety performance of the electrochemical apparatus 100.

As shown in FIG. 20, an embodiment of this application further provides an electric device 200 including the electrochemical apparatus 100 according to any one of the foregoing embodiments.

In the electrochemical apparatus 100 of the electric device 200 in this application, the fire extinguisher 30 and the first wire 41 are disposed on the first surface 121 of the second housing 12, the first part 411 of the first wire 41 is arranged with the first side 31 of the fire extinguisher 30, the second part 412 is arranged with the second side 32, and the third part 413 is arranged with the third side 33. This optimizes arrangement of the first wire 41 and is conducive to enlarging the sensing range of the first wire 41 without increasing the length of the first wire 41, so as to increase the response speed of the fire extinguisher 30 to abnormal high temperatures or flames, thereby improving the safety performance of the electrochemical apparatus 100 and improving the safety performance of the electric device 200.

In an embodiment, the electric device 200 includes but is not limited to any one of a drone, an electric two-wheeler, an electric tool, and a robot.

In addition, persons skilled in the art can also make other changes within the spirit of this application. Certainly, these changes made according to the spirit of this application shall fall within the scope of this application.

What is claimed is:

1. An electrochemical apparatus, comprising:
a first housing;
a second housing, arranged with the first housing in a first direction, wherein the second housing and the first housing are connected to each other to form an accommodating space, and the second housing comprises a first surface, the first surface facing the first housing in the first direction;
a cell assembly, disposed in the accommodating space;
a fire extinguisher, disposed on the first surface, wherein the fire extinguisher comprises a first side, a second side, a third side, and a fourth side, wherein the first side and the third side are arranged in a second direction perpendicular to the first direction, the second side and the fourth side are arranged in a third direction perpendicular to the first direction and the second direction, the first side is connected to the second side and the fourth side, and the third side is connected to the second side and the fourth side; and
a first wire, disposed on the first surface, wherein the first wire and the cell assembly are arranged along the first direction; and the first wire comprises a first part, a second part, and a third part, wherein the first part, the second part, and the third part are connected in sequence, a portion of the first part is opposite to the first side in the second direction, a portion of the second part is opposite to the second side in the third direction, a portion of the third part is opposite to the third side in the second direction, and the first part is connected to the first side.

2. The electrochemical apparatus according to claim 1, wherein the first wire further comprises a fourth part, the fourth part is connected to the third part, and a portion of the fourth part is opposite to the fourth side in the third direction.

3. The electrochemical apparatus according to claim 2, wherein when viewed in the first direction, the second part is apart from the second side, the third part is apart from the third side, and the fourth part is apart from the fourth side.

4. The electrochemical apparatus according to claim 2, further comprising a second wire, wherein the second wire is disposed on the first surface, and the second wire and the cell assembly are arranged along the first direction; and
the second wire comprises a fifth part, a sixth part, and a seventh part, wherein the fifth part, the sixth part, and the seventh part are connected in sequence, a portion of the fifth part is opposite to the third side in the second direction, a portion of the sixth part is opposite to the second side in the third direction, a portion of the seventh part is opposite to the first side in the second direction, and the fifth part is connected to the third side.

5. The electrochemical apparatus according to claim 4, wherein the second wire further comprises an eighth part, the eighth part is connected to the seventh part, and a portion of the eighth part is opposite to the fourth side in the third direction.

6. The electrochemical apparatus according to claim 5, wherein when viewed in the first direction, the sixth part is apart from the second side, the seventh part is apart from the first side, and the eighth part is apart from the fourth side.

7. The electrochemical apparatus according to claim 4, wherein
when viewed in the first direction, the second part and the fifth part intersect to form a first intersection point.

8. The electrochemical apparatus according to claim 7, wherein
when viewed in the second direction, the first intersection point is apart from the third side; and
when viewed in the third direction, the first intersection point is apart from the second side.

9. The electrochemical apparatus according to claim 5, wherein when viewed in the first direction, the first surface comprises a first region, wherein the first region is enclosed by the first wire, the second wire, the first side, the second side, and the third side, and the first region is apart from the fourth side.

10. The electrochemical apparatus according to claim 1, wherein
the first wire further comprises a first bent part, wherein the first part and the second part are connected through the first bent part;
when viewed in the second direction, the first bent part is apart from the fire extinguisher; and
when viewed in the third direction, the first bent part is apart from the fire extinguisher.

11. The electrochemical apparatus according to claim 4, wherein
the second wire further comprises a second bent part, wherein the fifth part and the sixth part are connected through the second bent part;
when viewed in the second direction, the second bent part is apart from the fire extinguisher; and
when viewed in the third direction, the second bent part is apart from the fire extinguisher.

12. The electrochemical apparatus according to claim 9, wherein
when viewed in the first direction, the fourth part and the eighth part intersect, and an intersection region of the fourth part and the eighth part and the fourth side are arranged along the third direction; and
when viewed in the first direction, the first surface comprises a second region, wherein the second region is enclosed by the first wire, the second wire, the third side, the fourth side, and the first side, and the second region is apart from the second side.

13. The electrochemical apparatus according to claim 12, wherein
when viewed in the first direction, the fourth part and the eighth part intersect to form a second intersection point, and the second intersection point is opposite to the fourth side in the third direction.

14. The electrochemical apparatus according to claim 13, wherein
the fourth part comprises a first end portion and a second end portion, wherein the first end portion is connected to the third part; and in the second direction, the first end portion is closer to the third part than the second end portion, and the second intersection point is located between the first end portion and the second end portion; and
the eighth part comprises a third end portion and a fourth end portion, wherein the third end portion is connected to the seventh part; and in the second direction, the third end portion is closer to the seventh part than the fourth end portion, and the second intersection point is located between the third end portion and the fourth end portion.

15. The electrochemical apparatus according to claim 12, wherein
a length of the fourth side in the second direction is greater than a length of the third side in the third direction; and
in the third direction, a minimum distance between the fourth part and the fourth side is a first distance; and in the second direction, a minimum distance between the third part and the third side is a second distance, wherein the first distance is less than the second distance.

16. The electrochemical apparatus according to claim 15, wherein
the first surface has a fifth side and a sixth side connected to each other, wherein the fifth side extends along the second direction, a portion of the fifth side is opposite to the fourth side
in the third direction, the sixth side extends along the third direction, and a portion of the sixth side is opposite to the third side in the second direction;
in the third direction, a minimum distance between the fourth part and the fifth side is a third distance; and
in the second direction, a minimum distance between the third part and the sixth side is a fourth distance, wherein the third distance is greater than the fourth distance.

17. The electrochemical apparatus according to claim 16, wherein the first distance is less than the third distance.

18. The electrochemical apparatus according to claim 4, wherein
in the first direction, a projection of the first wire overlaps a projection of the cell assembly; and/or
in the first direction, a projection of the second wire overlaps the projection of the cell assembly.

19. The electrochemical apparatus according to claim 1,
further comprising a third wire, wherein the third wire is disposed on the first surface, and the third wire and the cell assembly are arranged along the first direction; and
the third wire comprises a first section, a second section, and a third section; wherein the first section, the second section, and the third section are connected in sequence; a portion of the first section is opposite to the first side in the second direction, a portion of the second section is opposite to the fourth side in the third direction, a portion of the third section is opposite to the third side in the second direction, and the first section is connected to the first side; and
when viewed in the first direction, the first part and the first section intersect; and/or
when viewed in the first direction, the third part and the third section intersect.

20. An electric device, comprising the electrochemical apparatus according to claim 1.
